(19) United States
(12) Patent Application Publication
(10) Pub. No.: US 2026/0269480 A1
(43) Pub. Date: Sep. 10, 2026

(54) APPARATUS AND METHOD FOR CONTROLLING TRANSMISSIVE AND TRANSPARENT RECONFIGURABLE INTELLIGENT SURFACE IN WIRELESS COMMUNICATION SYSTEM

(71) Applicant: ELECTRONICS AND TELECOMMUNICATIONS RESEARCH INSTITUTE, Daejeon (KR)

(72) Inventors: Sun Gyu LEE, Daejeon (KR); Jung Ick MOON, Daejeon (KR); Jung Nam LEE, Daejeon (KR)

(73) Assignee: ELECTRONICS AND TELECOMMUNICATIONS RESEARCH INSTITUTE, Daejeon (KR)

(21) Appl. No.: 19/558,643

(22) Filed: Mar. 6, 2026

(30) Foreign Application Priority Data
Mar. 6, 2025 (KR) 10-2025-0028987

(51) Int. Cl. H01Q 9/06; H01Q 19/10

(52) U.S. Cl. CPC H01Q 9/065; H01Q 19/10

(57) ABSTRACT

Provided is an apparatus which controls a transmissive and transparent reconfigurable intelligent surface in a wireless communication system. The apparatus includes a transparent substrate, a metal mesh pattern formed in the form of a grid on the transparent substrate, a microstrip electric dipole located in a central portion of the metal mesh pattern and arranged in a first direction, a variable element mounted on a gap of the electric dipole and having an electrical characteristic varied depending on a bias voltage, a microstrip pad for applying the bias voltage to the variable element, and a ladder structure connected with unit cells neighboring in a second direction perpendicular to the first direction. A transmission phase is electronically controlled by varying the electrical characteristic of the variable element.

### CROSS-REFERENCE TO RELATED APPLICATIONS

This application claims priority under 35 U.S.C. § 119 to Korean Patent Application No. 10-2025-0028987 filed on Mar. 6, 2025, in the Korean Intellectual Property Office, the disclosures of which are incorporated by reference herein in their entireties.

### BACKGROUND

Embodiments of the present disclosure described herein relate to a communication device, and more particularly, relate to an apparatus and a method for controlling a transmissive and transparent reconfigurable intelligent surface in a wireless communication system.

A candidate frequency band of upper-mid FR3 which is a frequency lower than conventional 5th generation (5G) mobile communication based on a millimeter wave (mmWave) frequency band is expected in next-generation mobile communication (e.g., 6th generation (6G) mobile communication). Because the 6G mobile communication also has a propagation loss and a low diffraction characteristic due to a short wavelength as in 5G, it is expected that it will be difficult to perform outdoor-indoor communication. Because radio waves transmitted from an external base station do not pass through a thick outer wall of a building to be blocked, most radio waves in the outdoor-indoor communication transmit a thin glass window to enter indoors.

It is known that a transmission loss occurs by reflection due to an impedance mismatch according to a difference between permittivity of air and permittivity of glass. An existing technology used a frequency selective surface (FSS) or a metasurface for arranging a periodic structure on the surface to improve the transmission loss to propose a transmissive and transparent surface which is visually transparently to be attachable to glass, which may have propagation transmission performance compared to a condition in only glass.

The transmissive and transparent surface uses a transparent substrate, such as polyethylene terephthalate (PET) or polycarbonate (PC), and uses a metasurface as a metal mesh pattern designed with a grid of a spacing of hundreds of micrometers (μm) by forming a groove with a width of several micrometers (μm) on the transparent substrate and filling the groove with metal link, rather than an opaque metal pattern, to optimize transparency while maintaining a propagation characteristic. However, the existing technology helps to improve propagation transmission performance, but has a limitation in which a communication shadow area occurs as a transmission beam is still fixed at a size of a window in a window area.

Meanwhile, because a reconfigurable metasurface or a reconfigurable intelligent surface (RIS), which is recently developed, includes a low-cost variable element, such as a diode, to facilitate phase control using only simple voltage control, it is an active beam control surface capable of reflecting and transmitting a beam of an incident wave in a desired direction. The existing technology proposed a reflective and transparent RIS for applying the principle. It is impossible to apply outdoor-indoor communication due to the nature of a reflective scheme and a transmissive and transparent RIS capable of being applied to the outdoor-indoor communication is not yet reported.

### SUMMARY

Embodiments of the present disclosure provide an apparatus and a method for improving propagation transmission performance while ensuring visual transparency in a wireless communication system.

Embodiments of the present disclosure provide an apparatus and a method for optimizing transparency using a transparent substrate and a metal mesh pattern in a wireless communication system.

Embodiments of the present disclosure provide an apparatus and a method for actively controlling a transmission phase using a variable element (e.g., a varactor diode) in a wireless communication system.

Embodiments of the present disclosure provide an apparatus and a method for efficiently applying a bias voltage via a microstrip pad and a ladder structure in a wireless communication system.

Embodiments of the present disclosure provide an apparatus and a method for setting a center frequency and optimizing a transmission phase variable range via an arm structure and a parasitic patch in a wireless communication system.

According to an embodiment, an apparatus for controlling a transmissive and transparent reconfigurable intelligent surface may include a transparent substrate, a metal mesh pattern formed in the form of a grid on the transparent substrate, a microstrip electric dipole located in a central portion of the metal mesh pattern and arranged in a first direction, a variable element mounted on a gap of the electric dipole and having an electrical characteristic varied depending on a bias voltage, a microstrip pad for applying the bias voltage to the variable element, and a ladder structure connected with unit cells neighboring in a second direction perpendicular to the first direction. A transmission phase is electronically controlled by varying the electrical characteristic of the variable element.

According to an embodiment, an operating method for controlling a transmissive and transparent reconfigurable intelligent surface may include forming a microstrip electric dipole arranged in a first direction in a central portion of a unit cell on a transparent substrate, mounting a variable element on a gap of the electric dipole, making the unit cell transparent into a metal mesh pattern in the form of a grid, forming a microstrip pad for applying a bias voltage to the variable element, connecting unit cells neighboring in a second direction perpendicular to the first direction in a ladder structure, and varying an electrical characteristic of the variable element to electrically control a transmission phase.

### BRIEF DESCRIPTION OF THE FIGURES

The above and other objects and features of the present disclosure will become apparent by describing in detail embodiments thereof with reference to the accompanying drawings.

FIG. 1 illustrates a structure of a transmissive and transparent reconfigurable intelligent surface (RIS) unit cell according to an embodiment of the present disclosure.

FIG. 2 illustrates a transmissive and transparent RIS of a ladder structure according to an embodiment of the present disclosure.

FIGS. 3A and 3B illustrate transparency of a transmissive and transparent RIS unit cell according to an embodiment of the present disclosure.

FIGS. 4A and 4B illustrate the result of simulating transmission performance of a transmissive RIS unit cell according to an embodiment of the present disclosure.

FIG. 5 illustrates a structure of a transmissive RIS for applying a bias voltage according to an embodiment of the present disclosure.

FIG. 6 illustrates a block diagram of FIG. 5 according to an embodiment of the present disclosure.

FIG. 7 is a flowchart of an operating method for controlling a transmissive and transparent reconfigurable intelligent surface (RIS) according to an embodiment of the present disclosure.

### DETAILED DESCRIPTION

Terms used in the present disclosure are used to merely describe specified embodiments and are not intended to limit the scope of another embodiment. The singular expression may include plural expressions unless the context clearly indicates otherwise. All the terms used herein, which include technical or scientific terms, may have the same meaning that is generally understood by a person skilled in the art in the technical field described in the present disclosure. Terms defined in a general dictionary among the terms used in the present disclosure may be interpreted as the same or similar meaning as a contextual meaning of related technology, and unless clearly defined in the present disclosure, it is not interpreted in an ideal or excessively formal meaning. In some cases, even if terms are terms which are defined in the present disclosure, they may not be interpreted to exclude embodiments of the present disclosure.

A hardware access method will be described as an example in various embodiments of the present disclosure, which will be described below. However, because various embodiments of the present disclosure include a technology which uses both of hardware and software, they do not exclude a software-based access method.

Furthermore, in the detailed description and claims of the present disclosure, at least one of A, B, and C may refer to “only A”, “only B”, “only C”, or “any combination of A, B, and C”. Furthermore, “at least one of A, B, or C” or “at least one of A, B, and/or C” may refer to at least one of A, B, and C.

Hereinafter, the present disclosure relates to an apparatus and a method for controlling a transmissive and transparent reconfigurable intelligent surface in a wireless communication system. In detail, the present disclosure describes a unit cell design and implementation technology capable of actively controlling a transmission phase of a radio wave while maintaining visual transparency to expand outdoor-indoor communication coverage in a next-generation communication system.

In other words, the present disclosure adopts a varactor diode as a variable element to propose a transparent RIS unit cell. The transparent RIS unit cell may be designed as a structure capable of adopting a transparent substrate and a metal mesh pattern, which are an existing scheme, and being visually transparent and transmitting a radio wave. The transparent RIS unit cell may be designed with a microstrip pad for applying a bias voltage to a varactor diode of each unit cell and a ladder structure to electronically control a transmission phase. A unit cell structure may include an arm structure easy to finely set a center frequency and a parasitic patch capable of improving a transmission phase variable range.

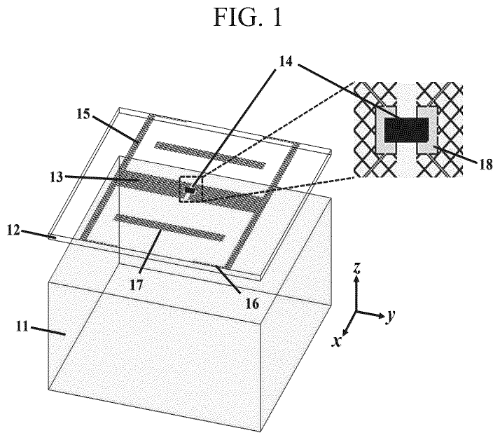

FIG. 1 illustrates a structure of a transmissive and transparent reconfigurable intelligent surface (RIS) unit cell according to an embodiment of the present disclosure.

Referring to FIG. 1, the unit cell has a structure in which it is attached to glass 11. A metal mesh pattern may be engraved on a polyethylene terephthalate (PET) substrate 12. According to an embodiment, the metal mesh pattern may be designed with a grid with a line width of several micrometers (μm) and a spacing of hundreds of micrometers (μm) to provide visual transparency while maintaining electrical conductivity of a metal pattern.

According to an embodiment, a main microstrip electric dipole 13 may be located in a y-axis direction which is a first direction on the unit cell. A varactor diode 14 for varying capacitance may be mounted on a gap located on a central portion of the electric dipole 13. The varactor diode 14 may be an element, capacitance of which varies depending on a reverse bias voltage.

According to an embodiment, as the transparent RIS unit cell is designed with a metal mesh pattern, the varactor diode 14 may not be easy to be mounted on the transparent RIS unit cell. Thus, a microstrip pad 18 for mounting the varactor diode 14 may be added.

According to an embodiment, a center frequency of the unit cell may be determined by a length of the main microstrip electric dipole 13 in the y-axis direction which is the first direction. A resonant frequency may move as the capacitance of the varactor diode 14 varies and a transmission phase observed at the center frequency may be actively controlled.

The electric dipoles 13 may be connected with neighboring unit cells on an x-axis which is a second direction via a microstrip 15 in the x-axis direction which is the second direction to be easy to apply a bias voltage. According to an embodiment, an additional electric dipole may be added, other than the electric dipole 13.

The arm structure 16 may be a structure capable of more finely adjusting the center frequency than the electric dipole 13. The structure of a parasitic patch 17 located separately from a ladder structure may be a structure capable of improving a transmission phase variable range using additional resonance.

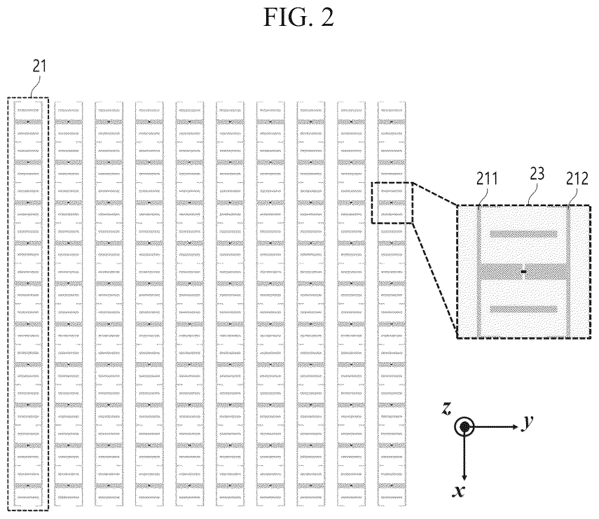

FIG. 2 illustrates a transmissive and transparent RIS of a ladder structure according to an embodiment of the present disclosure.

Referring to FIG. 2, unit cells connected in an x-axis direction which is a second direction may form one ladder structure 21. The unit cells may be connected with neighboring unit cells via a microstrip in the x-axis direction which is the second direction to be easy to apply a bias voltage. The entire RIS may be represented in a form in which a plurality of ladder structures are arranged in parallel with the x-axis which is the second direction while being away by a certain distance for a y-axis which is a first direction.

A bias voltage may be simultaneously applied to the respective ladder structures 21. Each ladder structure 21 may be designed as a structure for applying a ground voltage 0 V to the left 211 and applying a reverse bias voltage V_{R} to the right 212 to apply a reverse bias voltage. Such ladder structures 21 may be connected in parallel with each other in a y-axis direction to constitute the entire surface. An enlarged drawing 23 may show a detailed structure of the unit cell.

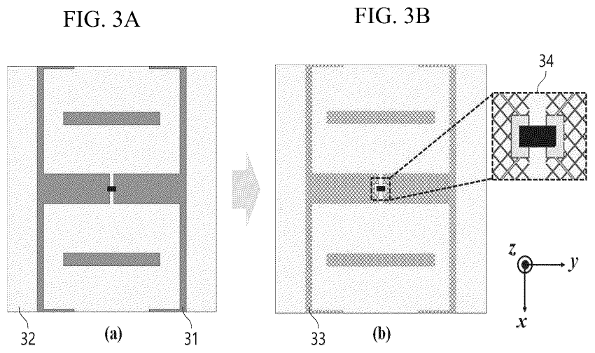

FIGS. 3A and 3B illustrate transparency of a transmissive and transparent RIS unit cell according to an embodiment of the present disclosure.

Referring to FIGS. 3A and 3B, first of all, the transmissive and transparent RIS unit cell may be designed as an opaque metal pattern structure 31 as in FIG. 3A. According to an embodiment, the metal pattern structure 31 may be formed on a transparent substrate 32, such as polyethylene terephthalate (PET) or polycarbonate (PC).

Thereafter, as in FIG. 3B, the metal pattern structure 31 may be transformed into a metal mesh pattern structure 33 to be transparent. According to an embodiment, the metal mesh pattern structure 33 may be designed with a grid with a spacing of hundreds of micrometers (μm) by forming a groove with a width of several micrometers (μm) on the transparent substrate 32 and filling the groove with metal ink. As a result, visual transparency may be optimized while maintaining electrical conductivity and a propagation characteristic of the metal pattern. An enlarged drawing 34 may show a detailed structure of the metal mesh pattern.

According to an embodiment, a transparency process may be to optimize performance of the transmissive and transparent RIS unit cell, which may transform an opaque metal pattern into a metal mesh pattern in an opaque metal pattern structure to implement a transmissive and transparent surface in which propagation transmission performance is more improved than glass.

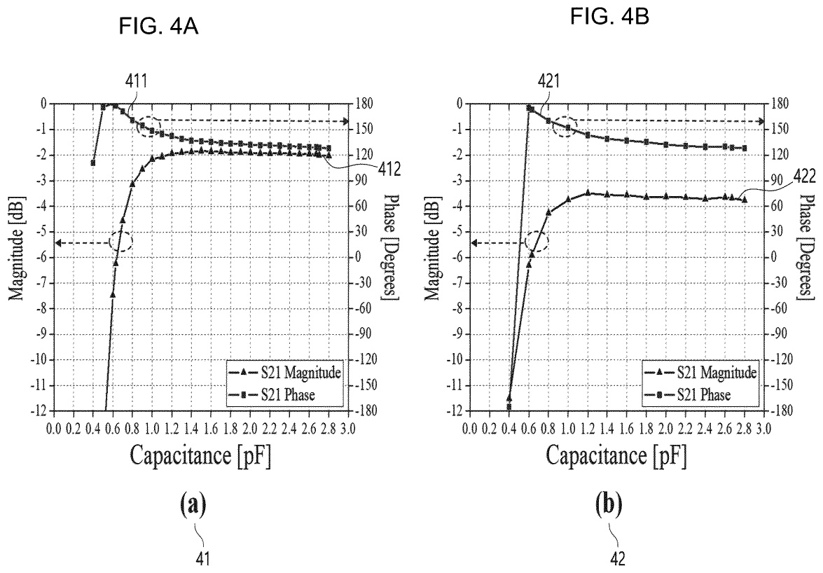

FIGS. 4A and 4B illustrate the result of simulating transmission performance of a transmissive RIS unit cell according to an embodiment of the present disclosure.

Referring to FIG. 4, FIG. 4A illustrates the result 41 of simulating an opaque metal pattern unit cell of FIG. 3A and may show changes in transmission coefficient magnitude 412 and transmission phase 411 observed at a center frequency of 15 GHz. In simulation of FIG. 4A, as a reverse bias voltage is applied to a varactor diode from 0 V to 30 V on the basis of the SMV 1405-079LF model of Skyworks, which operates in a 6G candidate frequency band, capacitance may vary from 2.67 pF to 0.63 pF and a transmission phase may vary up to 50 degrees within this range.

FIG. 4B illustrates the result 42 of simulating a transparent metal mesh pattern unit cell of FIG. 3B and may show changes in transmission coefficient magnitude 422 and transmission phase 421 observed at a center frequency of 15 GHz. There is a decrease in performance of the transmission coefficient magnitude and the phase range in the transparency process, but tendency may be maintained to be similar and the transmission phase may vary up to 44 degrees.

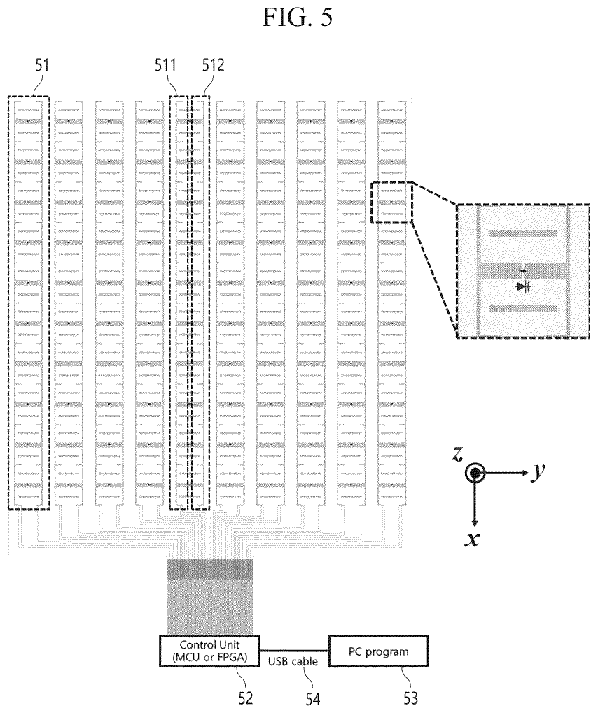

FIG. 5 illustrates a structure of a transmissive RIS for applying a bias voltage according to an embodiment of the present disclosure.

Referring to FIG. 5, a bias voltage may be simultaneously applied to unit cells connected in an x-axis direction which is a second direction by a ladder structure 51. According to an embodiment, the ladder structure 51 may be designed as a structure for applying a ground voltage 0 V to the left 511 and applying a reverse bias voltage V_{R} to the right 512.

According to an embodiment, the ladder structure 51 may be connected with a control unit 52 via a transparent or opaque microstrip.

According to an embodiment, an element, such as a micro controller unit (MCU) or a field programmable gate array (FPGA), may be used as the control unit 52.

According to an embodiment, a varactor diode may be controlled by a PC program 53 by a USB cable 54. The several ladder structures 51 may be arranged in parallel with an x-axis which is a second direction, while being away by a certain distance for a y-axis which is a first direction, to constitute a surface.

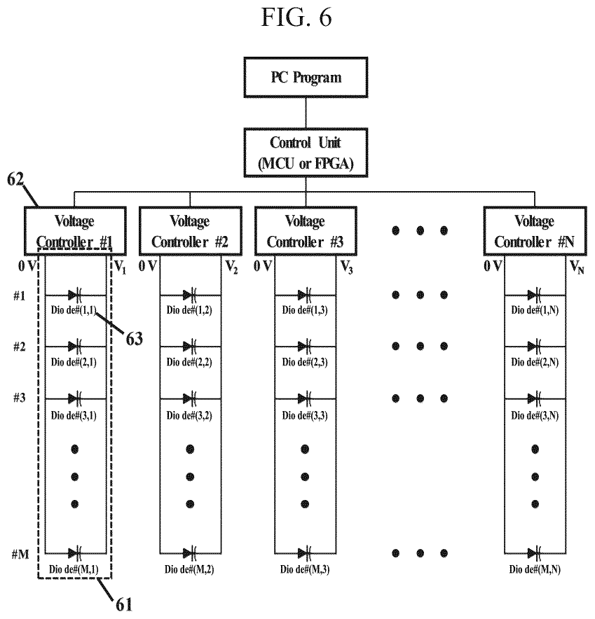

FIG. 6 illustrates a block diagram of FIG. 5 according to an embodiment of the present disclosure.

Referring to FIG. 6, each ladder structure 61 may be controlled via a voltage controller 62. According to an embodiment, each ladder structure 61 may apply a ground voltage 0 V to the left of each ladder structure 61 via the voltage controller 62 and may apply a reverse bias voltage {V₁, V₂, V₃, . . . , or V_{N}} to the right of each ladder structure 61.

According to an embodiment, a voltage of each ladder may be differently set by each voltage controller 62 and capacitance of a varactor diode 63 included in each ladder structure 61 may be differently set. As a result, a transmission phase of a unit cell included in each ladder structure 61 may be controlled.

According to an embodiment, the voltage controller 62 may be controlled by a PC program via a control unit, such as a micro controller unit (MCU) or a field programmable gate array (FPGA).

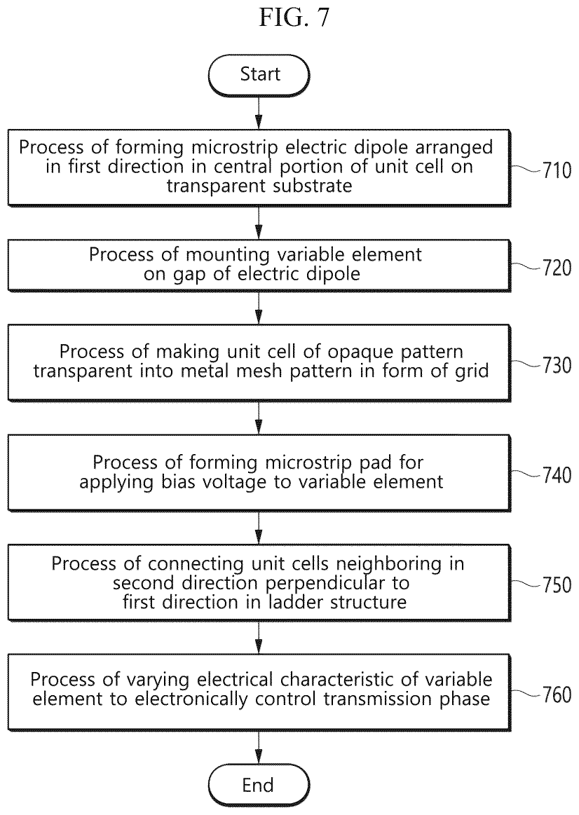

FIG. 7 is a flowchart of an operating method for controlling a transmissive and transparent reconfigurable intelligent surface according to an embodiment of the present disclosure.

Referring to FIG. 7, the operating method for controlling the transmissive and transparent reconfigurable intelligent surface may be composed of the following steps.

First of all, a process 710 of forming a microstrip electric dipole arranged in a first direction in a central portion of a unit cell on a transparent substrate may be performed. According to an embodiment, the length of the microstrip electric dipole may determine a center frequency. An arm structure for finely adjusting the center frequency and a parasitic patch for improving a transmission phase variable range may be further included.

Next, a process 720 of mounting a variable element on a gap of the electric dipole may be performed. According to an embodiment, the variable element may be a varactor diode, an electrical characteristic of which varies depending on a bias voltage.

Next, a process 730 of making a unit cell of an opaque pattern transparent into a metal mesh pattern in the form of a grid may be performed. According to an embodiment, the transparent substrate may be composed of polyethylene terephthalate (PET) or polycarbonate (PC). The metal mesh pattern may be designed with a line width with a width of several micrometers (μm) and a grid with a spacing of hundreds of micrometers (μm) to provide visual transparency while maintaining electrical conductivity.

Next, a process 740 of forming a microstrip pad for applying a bias voltage to the variable element may be performed.

Next, a process 750 of connecting unit cells neighboring in a second direction perpendicular to the first direction in a ladder structure may be performed. According to an embodiment, the ladder structure may simultaneously apply a bias voltage to a plurality of unit cells for the second direction and may be designed as a structure in which one side is grounded and the bias voltage is applied to the other side according to polarity of a varactor diode.

Finally, a process 760 of varying an electrical characteristic of the variable element to electronically control a transmission phase may be performed. At this time, the electronic control of the transmission phase may be performed via resonant frequency movement.

Methods according to claims of the present disclosure or embodiments described in the specification may be implemented in the form of hardware, software, or a combination of hardware and software.

When they are implemented with software, a computer-readable storage medium for storing one or more programs (or software modules) may be provided. The one or more programs stored in the computer-readable storage medium are configured to be executable by one or more processors in an electronic device. The one or more programs include instructions causing the electronic device to execute methods according to the claims of the present disclosure or the embodiments described in the specification.

Such a program (or a software module or software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs) or an another type of optical storage device, or a magnetic cassette. Alternatively, the program may be stored in a memory configured as a combination of some or all thereof. Furthermore, each configuration memory may be included in plural.

Furthermore, the program may be stored in an attachable storage device accessible over a communication network, such as the Internet, an intranet, a local area network (LAN), a wide area network (WAN), or a storage area network (SAN), or a communication network composed of a combination thereof. Such a storage device may access a device for performing an embodiment of the present disclosure via an external port. Furthermore, a separate storage device on the communication network may access a device for performing an embodiment of the present disclosure.

In detailed embodiments of the above-mentioned present disclosure, a component included in the present disclosure is expressed in a singular or plural form according to the proposed detailed embodiment. However, the expression in the singular or plural form is selected to be suitable for a situation proposed for convenience of description. The present disclosure is not limited to a singular component or a plurality of components. Even components expressed in the plural form may be configured in the singular form, but a component expressed in the singular form may be configured in the plural form.

The apparatus and the method according to various embodiments of the present disclosure may use a transparent substrate and a metal mesh pattern to ensure improved propagation transmission performance even while maintaining visual transparency.

Furthermore, the apparatus and the method according to various embodiments of the present disclosure may control a voltage via a varactor diode, a microstrip pad, and a ladder structure to actively adjust a transmission phase and effectively solve a shadow area of outdoor-indoor communication.

The effects that are achieved through the present disclosure may not be limited to the effects described above, and other advantages not described above may be more clearly understood from the following detailed description by those skilled in the art to which the present disclosure pertains.

Meanwhile, while the present disclosure has been described with reference to detailed embodiments, it will be apparent that various changes and modifications may be made without departing from the spirit and scope of the present disclosure. Therefore, the spirit and scope of the present disclosure is not limited and determined by the described embodiment and should be determined by the scope and equivalents of the claims as well as the scope of the claims which will be described below.

What is claimed is:

1. An apparatus for controlling a transmissive and transparent reconfigurable intelligent surface, the apparatus comprising:
a transparent substrate;
a metal mesh pattern formed in the form of a grid on the transparent substrate;
a microstrip electric dipole located in a central portion of the metal mesh pattern and arranged in a first direction;
a variable element mounted on a gap of the electric dipole and having an electrical characteristic varied depending on a bias voltage;
a microstrip pad for applying the bias voltage to the variable element; and
a ladder structure connected with unit cells neighboring in a second direction perpendicular to the first direction,
wherein a transmission phase is electronically controlled by varying the electrical characteristic of the variable element.

2. The apparatus of claim 1, wherein the metal mesh pattern provides visual transparency while maintaining electrical conductivity.

3. The apparatus of claim 1, wherein a length of the microstrip electric dipole determines a center frequency.

4. The apparatus of claim 1, further comprising:
an arm structure for finely adjusting a center frequency.

5. The apparatus of claim 1, further comprising:
a parasitic patch for improving a transmission phase variable range.

6. The apparatus of claim 1, wherein the variable element is a varactor diode having an electrical characteristic varied depending on a reverse bias voltage.

7. The apparatus of claim 1, wherein the ladder structure simultaneously applies the bias voltage to a plurality of unit cells.

8. The apparatus of claim 7, wherein the ladder structure has one side ground and the other side to which the bias voltage is applied.

9. The apparatus of claim 1, wherein the electronic control of the transmission phase is performed via resonant frequency movement.

10. The apparatus of claim 1, wherein the transparent substrate is composed of polyethylene terephthalate (PET) or polycarbonate (PC).

11. An operating method for controlling a transmissive and transparent reconfigurable intelligent surface, the operating method comprising:
forming a microstrip electric dipole arranged in a first direction in a central portion of a unit cell on a transparent substrate;
mounting a variable element on a gap of the electric dipole;
making the unit cell transparent into a metal mesh pattern in the form of a grid;
forming a microstrip pad for applying a bias voltage to the variable element;
connecting unit cells neighboring in a second direction perpendicular to the first direction in a ladder structure; and
varying an electrical characteristic of the variable element to electrically control a transmission phase.

12. The operating method of claim 11, further comprising:
providing visual transparency while electrical conductivity in forming the metal mesh pattern.

13. The operating method of claim 11, further comprising:
adjusting a length of the microstrip electric dipole to determine a center frequency in forming the microstrip electric dipole.

14. The operating method of claim 11, further comprising:
forming and controlling an arm structure for finely adjusting a center frequency.

15. The operating method of claim 11, further comprising:
forming and controlling a parasitic patch for improving a transmission phase variable range.

16. The operating method of claim 11, further comprising:
varying the electrical characteristic of the variable element by applying a reverse bias voltage.

17. The operating method of claim 11, further comprising:
simultaneously applying the bias voltage to a plurality of unit cells via the ladder structure.

18. The operating method of claim 17, further comprising:
grounding one side of the ladder structure and applying the bias voltage to the other side.

19. The operating method of claim 11, further comprising:
performing the electronic control of the transmission phase via resonant frequency movement.

20. The operating method of claim 11, wherein the transparent substrate is composed using polyethylene terephthalate (PET) or polycarbonate (PC) in forming the transparent substrate.
